(19) United States
(12) Patent Application Publication
(10) Pub. No.: US 2025/0313918 A1
(43) Pub. Date: Oct. 9, 2025

(54) BENEFICATION OF MANGANESE-BEARING ORE

(71) Applicant: Innoative Manganese Technologies SA (PTY) Ltd., Cornwall Hill (ZA)

(72) Inventor: Gerard Pretorius, Cornwall Hill (ZA)

(21) Appl. No.: 18/863,227

(22) PCT Filed: May 2, 2023
(86) PCT No.: PCT/IB2023/054551

§ 371 Date: Nov. 5, 2024

(30) Foreign Application Priority Data
May 13, 2022 (ZA) 2022/05305

(51) Int. Cl. C22B 47/00; C22B 1/06; C22B 3/04; C22B 3/44

(52) U.S. Cl. CPC C22B 47/00; C22B 1/06; C22B 3/04; C22B 3/44

(57) ABSTRACT

A process (10) for extracting manganese from manganese-bearing ore includes roasting (12.2) a feed admixture of particulate manganese-bearing ore (26), comprising Mn and Fe, and ammonium sulphate (24) at a first temperature T₁ to provide a sulphonated admixture comprising MnSO₄(s) and FeSO₄(s). The sulphonated admixture is roasted (12.3) at a second temperature T₂, which is higher than the first temperature T₁, to form a leachable admixture (30) comprising MnSO₄(s) and Fe₂O₃(s). The MnSO₄(s) is leached (16) in preference to the Fe₂O₃(s) from the leachable admixture (30) to provide a leachate (34, 38) rich in dissolved MnSO₄.

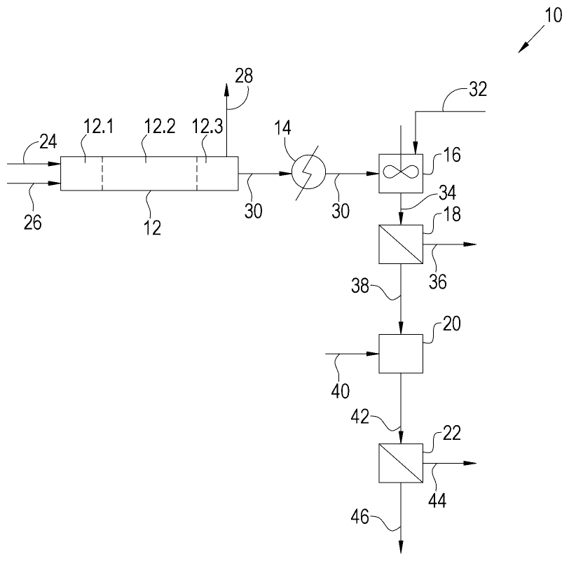

THIS INVENTION relates to beneficiation of manganese-bearing ore. In particular, the invention relates to a process for extracting manganese from manganese-bearing ore, and to manganese sulphate and manganese hydroxide and manganese oxide produced by said process.

MnSO₄ is a valuable salt. Apart from the metal and alloy industry, the need for MnSO₄ in the electrochemical battery industry is also growing.

MnSO₄ can be produced from manganese-bearing ore. South Africa accounts for about 78% of the world's manganese reserves, most of which are found in the Northern Cape Province. Typical manganese-bearing ore contains between about 15% and about 50% Mn, with the Mn being present as mixed oxides of different valences.

Many conventional processes are known in which manganese-bearing ore is roasted (typically in the presence of carbon at temperatures between about 900° C. and about 1100° C.) to reduce the manganese in the ore (from Mn³⁺ and Mn⁴⁺ to Mn²⁺) so that the reduced manganese can react with sulphuric acid (Mn²⁺ dissolves in sulphuric acid, whereas Mn³⁺ and Mn⁴⁺ do not). After leaching with sulphuric acid, solid impurities such as Fe from the manganese-bearing ore must be removed from an acidic manganese sulphate solution. Conventionally this is done by alkaline precipitation using a precipitation agent such as calcium carbonate. If a precipitation agent comprising calcium is used, gypsum (calcium sulphate) is however formed. Not only must the gypsum be dumped (or purified and sold), but it is difficult to wash entrained manganese sulphate from the gypsum. This typically leads to undesirable manganese yield lowering, i.e. manganese losses.

A process for extracting manganese from manganese-bearing ore, which does not suffer from at least some of the aforementioned difficulties, would be desirable.

According to the invention, there is provided process for extracting manganese from manganese-bearing ore, the process including
roasting a feed admixture of particulate manganese-bearing ore, comprising Mn and Fe, and ammonium sulphate at a first temperature T₁ to provide a sulphonated admixture comprising MnSO₄(s) and FeSO₄(s);
roasting the sulphonated admixture at a second temperature T₂, which is higher than the first temperature T₁, to form a leachable admixture comprising MnSO₄(s) and Fe₂O₃(s); and
leaching the MnSO₄(s) in preference to the Fe₂O₃(s) from the leachable admixture to provide a leachate rich in dissolved MnSO₄.

The process may include preventing or at least inhibiting ingress of oxygen, e.g. air, into an atmosphere within which the feed admixture is roasted. In one embodiment of the invention, the feed admixture is thus roasted in an atmosphere substantially free of oxygen.

By “substantially free of oxygen” is meant that, at a steady state for the process of the invention, the atmosphere within which the feed admixture is roasted does not include free oxygen from an environment external to a device within which the feed admixture is roasted, with the only free oxygen potentially being present within the atmosphere within which the feed admixture is roasted being oxygen released or generated as a result of the decomposition of Fe₂(SO₄)₃(s).

The MnSO₄(s) is typically leached from the leachable admixture using an aqueous leachant or aqueous solvent, e.g. water.

The manganese-bearing ore may have a Mn concentration of at least about 5% by mass, preferably at least about 10% by mass, most preferably at least about 20% by mass. Typically, the Mn concentration of the manganese-bearing ore does not exceed about 55% by mass.

The manganese-bearing ore may have an Fe concentration of at most about 20% by mass, or at most about 15% by mass, or at most about 10% by mass. Typically, the Fe concentration of the manganese-bearing ore is at least about 1% by mass.

Advantageously, MnSO₄(s) is quite soluble in water (i.e. about 70 g per 100 ml at 70° C.), whereas Fe₂O₃(s) is insoluble in water. Leaching the MnSO₄(s) from the leachable admixture with an aqueous leachant or aqueous solvent, e.g. water, thus leaves a leach residue or tailings in which the Mn:Fe mass ratio is much smaller than in the leachate. In other words, the leachate is thus enriched with Mn relative to Fe, whereas the tailings is enriched with Fe relative to Mn.

The first temperature T₁ may be in a range between about 300° C. and about 550° C., preferably between about 350° C. and about 500° C., most preferably between about 375° C. and about 475° C., e.g. about 450° C.

The second temperature T₂ may in a range between about 550° C. and about 750° C., preferably between about 600° C. and about 725° C., most preferably between about 650° C. and about 700° C., e.g. about 675° C.

In one embodiment of the invention, the feed admixture and the sulphonated admixture are roasted in a roasting stage employing a roaster such as a rotary kiln or the like, typically an externally heated or indirectly heated rotary kiln or calciner or the like, with the roaster having a continuum of roasting temperatures typically increasing from a feed inlet roasting temperature to a leachable admixture discharge temperature, with at least one zone of the roaster having roasting temperatures corresponding with the range of temperatures for the first temperature T₁, and at least one zone of the roaster having roasting temperatures corresponding with the range of temperatures for the second temperature T₂.

Preferably, ingress of air into the roaster is prevented or at least inhibited.

The roaster may have at least one zone with a roasting temperature Tᵢₙᵢₜᵢₐₗ below the range of temperatures for the first temperature T₁.

The roasting temperature Tᵢₙᵢₜᵢₐₗ may in a range between about 225° C. and about 375° C., preferably between about 250° C. and about 350° C., most preferably between about 275° C. and about 325° C., e.g. about 300° C., with the understanding that the temperature Tᵢₙᵢₜᵢₐₗ employed is lower than the first temperature T₁ employed.

The feed admixture may be roasted at the roasting temperature Tᵢₙᵢₜᵢₐₗ for a period of between about 30 minutes and about 360 minutes, preferably between about 60 minutes and about 240 minutes, most preferably between about 90 minutes and about 180 minutes, e.g. about 120 minutes.

The feed admixture may be roasted at the first temperature T₁ for a period of between about 30 minutes and about 360 minutes, preferably between about 60 minutes and about 240 minutes, most preferably between about 90 minutes and about 180 minutes, e.g. about 120 minutes.

The sulphonated admixture may be roasted at the second temperature T₂ for a period of between about 30 minutes and about 360 minutes, preferably between about 60 minutes and about 240 minutes, most preferably between about 90 minutes and about 180 minutes, e.g. about 120 minutes.

Without wishing to be bound by theory, the inventor believes that, when roasted at the first temperature T₁, or at the roasting temperature Tᵢₙᵢₜᵢₐₗ and then at the first temperature T₁, in an atmosphere preferably substantially free of oxygen, the following decomposition and reducing reactions take place:

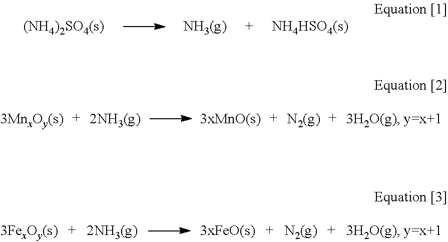

NH₃(g) is a strong reducing agent and the reducing reactions of Equations 2 and 3 thus take place at lower temperatures than oxidation reactions employed in the process of the invention.

The inventor further believes, without wishing to be bound by theory, that, when roasted at the first temperature T₁ in an atmosphere preferably substantially free of oxygen, the following decomposition and oxidation/sulphonating reactions take place:

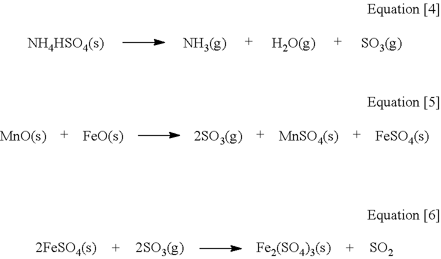

At the second temperature T₂, without wishing to be bound by theory, the inventor believes that the following decomposition reaction takes place:

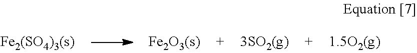

Surprisingly, even though SO₃(g), generated in the reaction of Equation 4 is highly oxidative, the Mn are not oxidised by the SO₃(g), in contrast to the Fe, but instead water soluble MnSO₄ produced by the reaction of Equation 5 remains. It thus appears that the SO₃(g) selectively oxidises the FeSO₄(s) in preference over the MnSO₄(s).

Advantageously, at the second temperature T₂, Fe₂(SO₄)₃(s) decomposes whereas MnSO₄(s) does not do so to any appreciable extent.

The process may include forming said feed admixture of particulate manganese-bearing ore and ammonium sulphate.

Forming said feed admixture of particulate manganese-bearing ore and ammonium sulphate may include, in a premixing stage, mixing particulate manganese-bearing ore and particulate ammonium sulphate.

Instead, forming said feed admixture of particulate manganese-bearing ore and ammonium sulphate may include feeding particulate manganese-bearing ore and particulate ammonium sulphate into a roasting stage, e.g. a roasting stage employing a rotary kiln, and mixing the particulate manganese-bearing ore and the particulate ammonium sulphate in the roasting stage.

The particulate manganese-bearing ore may have a D90 particle size in a range of about 25 μm to about 500 μm, preferably about 45 μm to about 250 μm, most preferably about 75 μm to about 212 μm, e.g. about 106 μm.

The particulate ammonium sulphate may have a D90 particle size in a range of about 25 μm to about 500 μm, preferably about 45 μm to about 250 μm, most preferably about 75 μm to about 212 μm, e.g. about 106 μm.

The process may include withdrawing off-gas produced by the roasting of the feed admixture and the roasting of the sulphonated admixture. Said off-gas may comprise H₂O(g), N₂(g), SO₂(g) and O₂(g).

Said off-gas may also include SO₃(g) and NH₃(g).

The process may include cooling the leachable admixture, obtained from roasting the sulphonated admixture at said second temperature T₂, prior to leaching the Mn(SO₄)(s) from the leachable admixture.

The leachable admixture may be cooled to a temperature T₃ in a range of about 15° C. to about 60° C., preferably about 20° C. to about 50° C., most preferably about 25° C. to about 40° C., e.g. about 30° C.

Typically, the leachable admixture is cooled using water as a coolant, e.g. in a jacketed auger with cooling water being passed through the jacket.

The MnSO₄(s) may be leached from the leachable admixture using an aqueous leachant or solvent, as hereinbefore indicated, at a temperature of between about 50° C. and about 90° C., preferably between about 60° C. and about 80° C., e.g. about 70° C.

The particulate manganese-bearing ore and the ammonium sulphate may be present in the feed admixture in a mass ratio of ore:ammonium sulphate of between about 1:1 and about 1:4, typically between about 1:2 and about 1:3. As will be appreciated, the mass ratio of ore:ammonium sulphate required however depends amongst other factors on the concentrations of Mn, Ca, Mg and Fe in the manganese-bearing ore, and the excess amount of ammonium sulphate required to achieve a desired manganese yield.

The leachable admixture may be leached for a leach period of between about 15 minutes and about 180 minutes, preferably between about 30 minutes and about 120 minutes, most preferably between about 45 minutes and about 90 minutes, e.g. about 60 minutes. In other words, a residence time of the leachable admixture in a leaching stage may correspond to said leach period.

Typically, the process includes separating the leachate from a leach residue. Said separation may be effected in any suitable solid-liquid separation manner, e.g. using filtration.

The process may include precipitating Mn(OH)₂ from the leachate. Mn(OH)₂ can readily be precipitated from the leachate using NH₄OH or NH₃(g), producing an Mn(OH)₂ precipitate and an (NH₄)₂SO₄ solution. This precipitated MnO₂ can be reacted with sulphuric acid to produce manganese (II) sulphate monohydrate of exceptional purity suitable, for example, for use in an electrochemical cell.

The process may include producing (NH₄)₂SO₄ crystals or powder from the (NH₄)₂SO₄ solution, e.g. by membrane separation and evaporation.

The process may include recycling (NH₄)₂SO₄ crystals or powder, i.e. (NH₄)₂SO₄(s), obtained from the (NH₄)₂SO₄ solution, to form part of the feed admixture.

The process of the invention can be implemented on a batch basis, a semi-batch basis, or as a continuous process.

The invention extends to MnSO₄ or Mn(OH)₂ or MnO₂ produced by a manufacturing process which includes a process for extracting manganese from manganese-bearing ore as hereinbefore described.

The invention will now be described, by way of example only, with reference to the following Example and with reference to the single diagrammatic drawing which shows one embodiment of a continuous process in accordance with the invention for extracting manganese from manganese-bearing ore.

### EXAMPLE

Manganese-bearing ore with the composition as set out in Table 1 was used to conduct manganese extraction tests.

TABLE 1

| Elements | Si | Al | Fe | Ca | Mg | Mn |
|---|---|---|---|---|---|---|
| Mn feed ore | 2.29% | 0.185% | 13.2% | 5.257% | 0.4% | 42.7% |
| composition | | | | | | |
| (% by mass) | | | | | | |
| Mass ratios | 1:18.7 | 1:122 | 1:3.2 | 1:8 | 1:107 | |
| of Mn to | | | | | | |
| other | | | | | | |
| elements in | | | | | | |
| the feed ore | | | | | | |
| Mn leachate | 28.4 mg/l | 7.95 mg/l | 12.1 mg/l | 762 mg/l | 1325 mg/l | 87100 mg/l |
| composition | | | | | | |
| Mass ratios | 1:3067 | 1:10956 | 1:7200 | 1:114.3 | 1:65.7 | |
| of Mn to | | | | | | |
| other | | | | | | |
| elements in | | | | | | |
| the leachate | | | | | | |
| Improvement | ×164 | ×90 | ×2250 | ×14.3 | (×1.63) | |
| in ratio from | | | | | (reduction) | |
| feed to | | | | | | |
| leachate | | | | | | |

250 g of the manganese-bearing ore of Table 1 was milled to −106 m. Similarly, 250 g of (NH₄)₂SO₄ was milled to −106 m. Both powders at −106 am were then blended to form an admixture, with the admixture being added to an open SiC crucible. The admixture was fired at 400° C. for 30 minutes, soon providing an atmosphere inside the crucible substantially free of oxygen as a result of the evolution of gases that replaced the air, then 450° C. for 1 hour, 500° C. for 1 hour and lastly 670° C. for 1 hour. A red powder of 323.5 g was recovered.

500 ml water was added to the red power to form a suspension and the temperature of the suspension was raised to 60-70° C. After 15 minutes of stirring, the suspension was filtered and washed. 600 ml MnSO₄ leachate was collected (refer to Table 1 for the composition of the leachate). The Mn units collected=87100 mg/l×0.6 l=52.26 g from a theoretical amount of 2.5×42.7=106.75 g Mn. Thus a 49% Mn recovery was achieved.

It can be seen from Table 1 that not only does the Fe concentration diminish in the leachate but also some other deleterious elements. The Mn/Mg mass ratio virtually remains the same.

The experiment was repeated with 1 part milled ore:2 parts milled (NH₄)₂SO₄ and a Mn recovery of 76% was achieved. By altering experimental conditions, e.g. by further increasing the mass ratio of manganese-bearing ore:ammonium sulphate, it was proven that a Mn recovery of >95% can be obtained.

Referring to the drawing, reference numeral 10 generally shows one embodiment of a continuous process in accordance with the invention for extracting manganese from manganese-bearing ore. The process 10 generally includes a roasting stage comprising a slightly inclined externally heated or indirectly heated rotary kiln 12 (often referred to as a rotary calciner), a cooler 14, a leaching stage comprising a leach vessel 16, a first filter 18, a precipitator 20 and a second filter 22.

The rotary kiln 12 is provided with an ammonium sulphate feed line 24 and a particulate manganese-bearing ore feed line 26. An off-gas withdrawal line 28 is provided adjacent a discharge end of the rotary kiln 12.

A leachable admixture transfer line 30 leads from the rotary kiln 12 to the cooler 14, and from the cooler 14 to the leach vessel 16. The leach vessel 16 is a stirred vessel provided with a mechanical agitator and is also provided with a water feed line 32.

A slurry transfer line 34 leads from the leach vessel 16 to the first filter 18, which is provided with a tailings withdrawal line 36 and a filtrate transfer line 38.

The filtrate transfer line 38 leads into the precipitator 20, which is also provided with an NH₃(g) feed line 40 and a slurry transfer line 42.

The slurry transfer line 42 leads to the second filter 22, which is provided with a Mn(OH)₂ precipitate withdrawal line 44 and an ammonium sulphate solution withdrawal line 46.

In order to extract manganese from manganese-bearing ore which also includes iron, a powder of the manganese-bearing ore with a D90 particle size of about 106 μm is continuously fed by means of the particulate manganese-bearing ore feed line 26 into the rotary kiln 12. Simultaneously, a powder of ammonium sulphate with a D90 particle size of about 106 μm is continually fed by means of the ammonium sulphate feed line 24 into the rotary kiln 12. A mass ratio of the powdered manganese-bearing ore to the ammonium sulphate powder being fed into the rotary kiln 12 depends on the composition of the manganese-bearing ore. For the ore shown in Table 1, the mass ratio would be about 1:2.4.

The mass ratio required, for the manganese-bearing ore of Table 1, can be determined as follows (based on a 100 gram of manganese-bearing ore):
Fe 13.2%=0.236 mol×1.5=0.354 mol SO₃ required to form Fe₂(SO₃)₃
Ca 5.3%=0.133 mol×1=0.133 mol SO₃ required to form CaSO₄
Mg 0.4%=0.017 mol×1=0.017 mol SO₃ required to form MgSO₄
Mn 42.7%=0.776 mol×1=0.776 mol SO₃ required to form MnSO₄
Ba 1.36%=0.010 mol×1=0.01 mol SO₃ required to form BaSO₄ (Ba not shown in Table 1)
Total SO₃ required=1.29 mol

It follows that 100 g feed of the manganese-bearing ore requires 1.29 mol (NH₄)₂SO₄×132 g/mol=170.28 g+15% excess used experimentally=approximately 200 g (NH₄)₂SO₄, i.e. a manganese-bearing ore:ammonium sulphate mass ratio of about 1:2.

Experimentally an efficiency or Mn yield of about 80% was achieved. By using 20% more (NH₄)₂SO₄ it is believed that the sulphonation reactions will proceed almost to completion. This provides a required manganese-bearing ore:ammonium sulphate mass ratio of about 1:2×1.2=1:2.4.

NH₃(g) will always be present in excess as 2 mol NH₃(g) is released for every mol of SO₃(g) released inside the rotary kiln 12 (see Equation 1+Equation 4).

The particulate manganese-bearing ore and the ammonium sulphate are fed from hoppers (not shown) through inlet seals (not shown, and typically used only if the hoppers do not provide adequate sealing against air ingress) so as to inhibit the introduction of air into the rotary kiln 12.

In the rotary kiln 12, the particulate manganese-bearing ore and the ammonium sulphate powder are admixed as a result of the rotary action of the rotary kiln 12 and a resultant admixture is roasted, in an atmosphere substantially free of oxygen over most of the length of the rotary kiln 12, as the admixture travels through the rotary kiln 12 as a result of the rotation of the rotary kiln 12 and as a result of the slight inclination of the rotary kiln 12 to the horizontal.

In an inlet zone 12.1 of the rotary kiln 12, the admixture is roasted or subjected to pyrolysis conditions (i.e. in an atmosphere substantially free of oxygen) at a roasting temperature Tᵢₙᵢₜᵢₐₗ which typically ranges between about 300° C. and about 350° C., for a period of about 60 minutes. As the admixture progresses towards a discharge end of the rotary kiln 12, the admixture is roasted in an intermediate zone 12.2 at a first temperature T₁, which typically is in a range of about 400° C. to about 500° C., for a period of about 180 minutes. Thereafter, the admixture enters an end zone 12.3 of the rotary kiln 12 adjacent a discharge end of the rotary kiln 12. In the end zone 12.3, the admixture is roasted at a second temperature T₂, which typically is in a range of about 550° C. to about 675° C., for a period of about 120 minutes. The total residence time of material passing through the rotary kiln 12 is thus typically about 360 minutes.

In the inlet zone 12.1, the ammonium sulphate decomposes in an atmosphere substantially free of oxygen to form ammonia gas in situ presumably in accordance with Equation 1 hereinbefore described, with the gaseous ammonia then reacting with manganese oxides and iron oxides to reduce these oxides presumably in accordance with Equations 2 and 3 hereinbefore described. Nitrogen gas and water vapour evolve, and these gases are withdrawn through the off-gas withdrawal line 28, together with any unreacted ammonia gas.

In the intermediate zone 12.2, in an atmosphere still substantially free of oxygen, more gaseous ammonia, and sulphur trioxide, are produced presumably in accordance with Equation 4 hereinbefore described, and MnO(s) and FeO(s) react with the sulphur trioxide to form, it is believed, MnSO₄(s) and FeSO₄(s) presumably in accordance with Equation 5 hereinbefore described. The FeSO₄(s) reacts further with the sulphur trioxide, it is believed, presumably in accordance with Equation 6 hereinbefore described, to form Fe₂(SO₄)₃(s).

In the end zone 12.3, it is believed the Fe₂(SO₄)₃(s) is decomposed presumably in accordance with Equation 7 hereinbefore described, producing Fe₂O₃(s), SO₂(g) and gaseous oxygen. The SO₂(g) and oxygen, water vapour and any unreacted sulphur trioxide from the zones 12.2 and 12.3 are also withdrawn by means of the off-gas withdrawal line 28.

As will be appreciated, instead of employing a single rotary kiln 12 with multiple temperature zones, separate rotary kilns or other roasters can be used to roast the feed admixture and the sulphonated admixture at different temperatures. As will be appreciated, one advantage of using separate rotary kilns or other roasters is that it would be easier to eliminate oxygen from the atmosphere within which the feed admixture is roasted, as the atmosphere within which the feed admixture is roasted can be separated from the atmosphere within the Fe₂(SO₄)₃(s) is decomposed and which may thus include oxygen released by the decomposition of the Fe₂(SO₄)₃(s).

The leachable admixture is withdrawn from the rotary kiln 12 through a discharge seal (not shown) and transferred by means of the leachable admixture transfer line 30 to the cooler 14, where the leachable admixture is cooled using plant cooling water in an indirect heat transfer arrangement to a temperature of about 30° C., before being transferred to the leach vessel 16 by means of the leachable admixture transfer line 30. Instead of, or in addition to using a separate cooler 14, the rotary kiln 12 may have an integral cooling zone.

Water is fed by means of the water feed line 32 into the leach vessel 16 and is admixed with the leachable admixture using the mechanical stirrer of the leach vessel 16. Typically, leaching of the leachable admixture in the leach vessel 16 with water as leachant or solvent is effected at a temperature of about 60° C. to 70° C. If necessary, the leach vessel 16 can thus be a heated vessel. Alternatively, the leachable admixture and the water fed into the leach vessel 16 may be at a sufficiently high temperature to ensure that leaching takes place at the desired temperature.

In the leach vessel 16, the water leaches MnSO₄(s) from the leachable admixture. The leachable admixture has a residence time of about 60 minutes in the leach vessel 16 and is then transferred as a slurry by means of the slurry transfer line 34 to the first filter 18.

In the first filter 18, leach residue or tailings is separated from the slurry and withdrawn by means of the tailings withdrawal line 36. A leachate or filtrate rich in dissolved manganese sulphate is withdrawn from the first filter 18 and is transferred to the precipitator 20. As will be appreciated, as manganese sulphate is quite soluble in water, in contrast to FeSO₃(s) which is substantially insoluble in water, the leach residue or tailings which is withdrawn by means of the tailings withdrawal line 36 is depleted in manganese sulphate, whereas the leachate or filtrate transferred by means of the filtrate transfer line 38 to the precipitator 20 is enriched in manganese sulphate, with most of the FeSO₃(s) reporting to the leach residue or tailings.

In the embodiment of the process of the invention illustrated in the drawing, Mn(OH)₂ is precipitated from the leachate fed to the precipitator 20. This is achieved by feeding gaseous ammonia by means of the NH₃(g) feed line 40 into the precipitator 20 and allowing Mn(OH)₂ to precipitate. Although not shown, the precipitator 20 may be a stirred vessel.

A slurry of the Mn(OH)₂ precipitate is transferred by means of the slurry transfer line 42 to the second filter 22, where the Mn(OH)₂ precipitate is separated from an ammonium sulphate solution and withdrawn by means of the Mn(OH)₂ precipitate withdrawal line 44. The ammonium sulphate solution is withdrawn by means of the withdrawal line 46.

The withdrawn ammonium sulphate solution can be treated to produce ammonium sulphate crystals or powder, e.g. by membrane separation and evaporation with the ammonium sulphate crystals or powder then being recycled to the rotary kiln 12 as part of the ammonium sulphate in the ammonium sulphate feed line 24.

The Mn(OH)₂ withdrawn by means of the Mn(OH)₂ precipitate withdrawal line 44 can be treated to convert the Mn(OH)₂ to very pure MnO₂. The resultant MnO₂ can be reacted with sulphuric acid to produce manganese (II) sulphate monohydrate of exceptional purity suitable, for example, for use in an electrochemical cell.

The process 10, as illustrated, advantageously does not require digesting of a roasted manganese-bearing ore or concentrate with sulphuric acid. The process 10, as illustrated, advantageously also does not require alkaline precipitation of soluble impurities such as Fe. Importantly, the process 10, as illustrated, also allows for recycling of a bulk reagent (ammonium sulphate).

Manganese-bearing ore typically includes significant concentrations of Ca and Mg (see for example Table 1). In the process of the invention, as illustrated, so-called dead burnt gypsum or dead burnt plaster is advantageously formed. Thus, although anhydrous CaSO₄ is formed in the process of the invention, the CaSO₄ does not rehydrate to form CaSO₄·2H₂0 when leached with water. This greatly facilitates aqueous leaching, as CaSO₄-2H₂0 acts as a sponge that would undesirably capture valuable MnSO₄. A similar issue in conventional processes arises because of the formation of silica gel, which is difficult to remove by filtration, but advantageously in the process of the invention, as illustrated, SiO₂ is formed which is easily removed by filtration.

1. A process for extracting manganese from manganese-bearing ore, the process including
roasting a feed admixture of particulate manganese-bearing ore, comprising Mn and Fe, and ammonium sulphate at a first temperature T₁ to provide a sulphonated admixture comprising MnSO₄(s) and FeSO₄(s);
roasting the sulphonated admixture at a second temperature T₂, which is higher than the first temperature T₁, to form a leachable admixture comprising MnSO₄(s) and Fe₂O₃(s); and
leaching the MnSO₄(s) in preference to the Fe₂O₃(s) from the leachable admixture to provide a leachate rich in dissolved MnSO₄.

2. The process according to claim 1, which includes preventing or at least inhibiting ingress of oxygen into an atmosphere within which the feed admixture is roasted.

3. The process according to claim 1, wherein the MnSO₄(s) is leached from the leachable admixture using an aqueous leachant or aqueous solvent.

4. The process according to claim 1, wherein the first temperature T₁ is in a range between 300° C. and 550° C.

5. The process according to claim 4, wherein the first temperature T₁ is between 350° C. and 500° C., or between 375° C. and 475° C.

6. The process according to claim 1, wherein the second temperature T₂ is in a range between 550° C. and 750° C.

7. The process according to claim 6, wherein the second temperature T₂ is between 600° C. and 725° C., or between 650° C. and 700° C.

8. The process according to claim 1, wherein the feed admixture and the sulphonated admixture are roasted in a roasting stage employing a roaster, with the roaster having a continuum of roasting temperatures increasing from a feed inlet roasting temperature to a leachable admixture discharge temperature, with at least one zone of the roaster having roasting temperatures corresponding with the range of temperatures for the first temperature T₁, and at least one zone of the roaster having roasting temperatures corresponding with the range of temperatures for the second temperature T₂.

9. The process according to claim 8, wherein the roaster has at least one zone with a roasting temperature Tᵢₙᵢₜᵢₐₗ below the range of temperatures for the first temperature T₁, the roasting temperature Tᵢₙᵢₜᵢₐₗ being in the range of between 225° C. and 375° C.

10. The process according to claim 9, wherein the roasting temperature Tᵢₙᵢₜᵢₐₗ is between 250° C. and 350° C.

11. The process according to claim 9, wherein the roasting temperature Tᵢₙᵢₜᵢₐₗ is between 275° C. and 325° C., with the understanding wherein the temperature Tᵢₙᵢₜᵢₐₗ employed is lower than the first temperature T₁ employed.

12. The process according to claim 1, wherein the particulate manganese-bearing ore and the ammonium sulphate are present in the feed admixture in a mass ratio of ore:ammonium sulphate of between 1:1 and 1:4.

13. The process according to claim 12, wherein the particulate manganese-bearing ore and the ammonium sulphate are present in the feed admixture in a mass ratio of ore:ammonium sulphate of between 1:2 and 1:3.

14. The process according to claim 1, which includes precipitating Mn(OH)₂ from the leachate using NH₄OH or NH₃(g), producing an Mn(OH)₂ precipitate and an (NH₄)₂SO₄ solution.

15. The process according to claim 14, which includes producing (NH₄)₂SO₄ crystals or powder from the (NH₄)₂SO₄ solution, and recycling (NH₄)₂SO₄ crystals or powder, i.e. (NH₄)₂SO₄(s), obtained from the (NH₄)₂SO₄ solution, to form part of the feed admixture.

16. (canceled)
